(19) United States
(12) Patent Application Publication
(10) Pub. No.: US 2004/0001944 A1
(43) Pub. Date: Jan. 1, 2004

(54) Display sheet having microporous suction sheet

(75) Inventor: Katsuhiko Kuwahata, Kanagawa (JP)

Correspondence Address: McGinn & Gibb, PLLC, Suite 200, 8321 Old Courthouse Road, Vienna, VA, 22182-3817, US

(73) Assignee: ACT Corporation, Kawasaki-shi (JP)

(21) Appl. No.: 10/364,466

(22) Filed: Feb. 12, 2003

(30) Foreign Application Priority Data
Jul. 1, 2002 (JP) 2002-225348

(51) Int. Cl. B32B 3/26

(52) U.S. Cl. 428/315.7; 428/32.39; 428/32.17; 428/32.18; 428/32.32

(57) ABSTRACT

The display sheet comprises: a sheet-like member, which comprises a support, such as a sheet of paper and a plastic film, and a 30 to 500 micron thick flexible microporous suction sheet which is disposed on a back surface side of the support and in which an infinite number of fine and flexible depression pores 5 to 300 microns in diameter are formed; and a release film, which releasably covers a surface of the microporous suction sheet to protect the microporous suction sheet, is 10 to 100 micron thick and has a smooth surface.

Adhering workability, release workability, storability and reusability are improved by providing the microporous suction sheet.

Display contents are printed on a printing receptive layer formed on a front surface side of the support, on the microporous suction sheet or on a printing receptive layer formed on the microporous suction sheet. This display sheet is suitable for front surface application when display contents are printed on the printing receptive layer and for the back surface application when display contents are printed on the microporous suction sheet or on a printing receptive layer formed on the microporous suction sheet.

### BACKGROUND OF THE INVENTION

1. Field of the Invention

The present invention relates to a display sheet which permits easy sticking to relatively smooth surfaces of indoor walls, windows, signboards and outdoor windows of shops, dwelling houses, etc, vehicles, etc., can be easily manually stripped as required, and provides good storability for reuse. Also, the present invention relates to a display sheet for back surface application which is stuck to the back surface of a transparent window so that people can see its display surface from the front side, and which simultaneously permits the printing of its display surface and the restoration of adsorbability. In the description and claims, a display sheet is used in a broad sense and hence includes all displays on which a display is created by various types of printing etc., in addition to advertisements and public relations.

2. Description of the Related Art

A display sheet will be described below by taking an advertising poster and sales promotion POP advertising (hereinafter referred to as a sheet for advertising posters) as examples. Conventionally, in cases where a sheet for advertising posters which comprises a sheet of paper or a plastic film is stuck to an adherend, such as a window, a windowpane and a signboard, the sheet for advertising posters is often stuck to the adherend by being thumbtacked or taped down at its four corners.

On the other hand, a sheet for advertising posters with paste in which an adhesive is applied to the whole area of the back surface of the sheet for advertising posters so that the sheet can be stuck to every place, what is called a sheet for advertising posters with paste for front surface application is known and widely used. Furthermore, what is called a sheet for advertising posters with paste for back surface application whose printing surface is applied to the back surface of a transparent window by use of an adhesive has long been used in order to prevent stripping by wind or intentionally. However, the greatest disadvantage of these sheets resides in the fact that they cannot be neatly stuck due to the mixing of air, occurrence of wrinkles and the like during sticking to windowpanes, walls, etc., and that they cannot be easily stripped again.

In order to make this difficult work easy, it is a general practice to spray soap water beforehand onto a window, wall, etc., which are adherends, to place a poster with paste on the adherend and to stick the poster while pushing out the soap water by means of a squeegee. However, this method cannot be applied to a sheet for advertising posters made of paper which has low resistance to water although this method is applicable when a sheet for advertising posters has high resistance to water as a plastic film.

As another method that makes the sticking work easy, there is also taken up a practice in which the adhesive strength of a sheet for advertising posters with paste is made very weak so that the sheet can be stripped in the case that sticking is unsuccessful. However, only a professional can stick it neatly without the mixing of air and the occurrence of wrinkles and this work cannot be done by an amateur who performs sticking work for the first time.

On the other hand, a sheet for advertising posters which has once been stuck is eventually removed and because of the strong adhesive strength of an adhesive, the stripping work requires much labor and a long time. Furthermore, a sheet for advertising posters with paste which has once been stuck is sometimes to be desired to be stripped for reuse if stripping is possible. However, when an adhesive was used, the surface tackiness is great and the amount of adhering dust is also large, with the result that even when the sheet for advertising posters can be stripped, in the present state it is impossible to safely store the sheet until it is reused again.

As described above, whether for front surface application or back surface application, the greatest defect of a sheet for advertising posters with paste resides in the fact that sticking work is difficult, that stripping work after use requires much labor and a long time and that reuse is impossible. Furthermore, a sheet for advertising posters with paste for back surface application is generally applied by a transparent double-faced adhesive tape to the printing surface, which is a display surface, and this practice poses problems of high cost and a high frequency of failure.

The present invention relates to an epoch-making display sheet which solves the problems in the difficulty with which sticking work is performed and the ease with which stripping work is performed whether the display sheet is for front surface application or back surface application. In particular, this display sheet can be used in wide applications from small areas to large areas of 1 to 3 m² and enables an amateur to perform sticking work easily and in a short time not only in front surface application, but also in back surface application which involves sticking from the back side of a transparent window. Furthermore, a display sheet according to the present invention can solve the impossibility of reuse which existed in conventional sheets for advertising posters with paste.

### SUMMARY OF THE INVENTION

In view of the foregoing and other drawbacks, disadvantages and problems of the conventional methods and structures, an object of the present invention is to provide an epoch-making display sheet which combines the ease with which sticking work is performed and the possibility that the sheet can be reused after its use and stripping. Also, another object of the invention is to provide a display unit suitable for back surface application which simultaneously permits the printing of its display surface and the restoration of adsorbability.

In order to achieve the above-described objects, the present invention provides a display sheet having a microporous suction sheet which enables even an amateur to easily perform sticking work by using the microporous suction sheet having the function of adsorption without using an adhesive in the sticking of the display sheet, can be easily stripped after use, has good storability after use and permits reuse. Alternatively the present invention provides a display sheet which permits printing without losing adsorbability by performing printing directly on the microporous suction sheet having the function of adsorption. The adsorption of a microporous suction sheet functions such that when the microporous suction sheet is depressed against an adherend, the thickness of the microporous suction sheet is temporarily reduced and part of the air in an infinite number of depression pores formed on the microporous suction sheet is eliminated to produce a negative pressure, with the result that what is called the suction sheet effect is displayed.

More specifically, the present invention provides a display sheet with microporous suction sheet comprising: a sheet-like member, which comprises a 30 to 500 micron thick soft microporous suction sheet in which an infinite number of fine and flexible depression pores of 5 to 300 microns in diameter are formed; and a release film, which is releasably stuck to the microporous suction sheet to protect the microporous suction sheet, is 10 to 100 micron thick and has a yield point elongation of not less than 2%. In this display sheet, the surface of the sheet-like member can become a display surface of display contents. The display surface is generally printed to be displayed. Printing includes inkjet printing, screen printing, offset printing, photogravure printing, seal printing and the like.

The microporous suction sheet of the present invention includes a 30 to 500 micron thick expanded resin coated layer which is formed by applying, for example, a chemical solution prepared so as to form fine air bubbles by mechanically blowing air into an acrylic emulsion liquid and/or a urethane emulsion liquid to the back surface of a support etc. by means of a comma coater and sufficiently drying the chemical solution to remove moisture. Thus, the microporous suction sheet comprises an infinite number of fine air bubbles of 5 to 300 microns in diameter and a flexible resin, for example, an acrylic resin and/or a urethane resin and on the surface of the microporous suction sheet are formed an infinite number of 5 to 300 micron diameter depression pores having the function of adsorption, as shown in FIG. 2. The depression pores communicate with inner air bubbles and the air bubbles are connected together by fine-diameter tubes. These numerous depression micropores display what is called pressure-sensitive adsorbability and has the characteristic of pressure-sensitive adsorption to every adherend if a surface of the adherend to which the microporous suction sheet is to be stuck is smooth. It is possible to use a smooth glass surface, a plastic film, a painted smooth wood surface, a smooth metal surface and a smooth stone surface as the adherend. Furthermore, because manual stripping is easy and the microporous suction sheet does not have so much tackiness as an adhesive, the microporous suction sheet physiologically adapts to human beings. Resins which form a flexible microporous suction sheet are disclosed in the Japanese Patent Publication No. 5-81614B. Formed depression pores have not always a section of a perfect circle and the size of the depression pores is not constant. The 5 to 300 micron diameter depression pores referred to in the present invention mean depression pores having a spanning pore size of 5 to 300 microns on average.

Furthermore, the sheet-like member can comprise a support and the above-described microporous suction sheet can be formed on the back surface side of the support. The support of the present invention can be formed from any of paper, synthetic paper, polyvinyl chloride film, polyester film, polyethylene film, polypropylene film, cloth, etc. and preferably, the support of the present invention is formed from a thing which enables a printing receptive layer to be formed on a surface thereof. Although a screen printing receptive layer, an offset printing receptive layer, a photogravure printing receptive layer and a seal printing receptive layer may be used as the printing receptive layer formed on the support, preferably, an inkjet printing receptive layer is formed. An inkjet printing receptive layer is a coating layer which is treated so as to instantaneously absorb a water base ink of an inkjet and an oil base ink of an inkjet and suppress the spreading of the ink. This coating layer is formed by hardening a specific inorganic pigment or a specific organic dye with a resin and in many cases, the surface of the coating layer provides a fine rough surface. However, even when an inkjet printing receptive layer is coated on the surface of the support, there are also inkjet printing receptive layers whose surface is very smooth as in commercial inkjet media, such as sheets of computer inkjet printer paper, and such inkjet printing receptive layers may be used.

Although such a microporous suction sheet has begun to be used as a kind of adhesive tape, in the present invention there is provided a display sheet in which a sheet-like member is constituted by a microporous suction sheet and the surface of this sheet-like member is used as a display surface. As a result, even a large-sized display sheet which is as large as several meters long and wide and has enabled only a professional to perform sticking work, can now be easily stuck by an amateur.

Furthermore, the display sheet of the present invention can have a protective film stuck to a surface of a sheet-like member. Furthermore, by forming the surface of the support, the surface of the printing receptive layer or the surface of the protective film as a rough surface, it becomes easy to reuse the display sheet after stripping, which has so far been impossible. That is, by forming the surface of the support, the surface of the printing receptive layer or the surface of the protective film as a substantially rough surface, in winding the display sheet in roll form and in unwinding thereof, it is ensured that the microporous suction sheet comes into slidable contact with this rough surface during winding, making it possible to wind the display sheet smoothly and firmly.

As described in detail, preferably, the storage of the display sheet is such that as shown in FIGS. 4A to 4C, the display sheet can be stored in roll form. However, in the case of conventional sheets for advertising posters with paste, in manually stripping such a conventional sheet stuck to glass etc., for reuse for example, and winding the stripped sheet in roll form without a sheet of release paper attached, it is impossible to ensure neat winding because of direct contact between an exposed adhesive and a printing receptive layer etc. Even when winding is possible, an adhesive joint between the adhesive and the printing receptive layer would be forcedly stripped during unwinding and, therefore, the surface of the printing receptive layer is damaged, with the result that the reuse of the sheets for advertising posters was impossible.

In contrast, because a microporous suction sheet is provided in place of an adhesive as in the display sheet of the present invention, the microporous suction sheet does not adhere to surrounding things unnecessarily because of nonexistence of surface tackiness and handling is very easy. Furthermore, because of the nonexistence of surface tackiness, it is easy to store the display sheet in roll form without the use of a release film and unwinding becomes also easy, making it possible to reuse the display sheet.

When winding the display sheet for reuse, the microporous suction sheet comes into direct contact with the surface of the support, the surface of the printing receptive layer or the surface of the protective film. If the surface of the support, printing receptive layer or protective film is a substantially rough surface, the microporous suction sheet slides on this surface without adsorbing this surface and the display sheet can be wound while being somewhat tightened, with the result that the display sheet can be wound very firmly and compactly. If the surface of the support, printing receptive layer or protective film is very smooth, the adsorbability with the microporous suction sheet increases and it becomes less easy to wind the display sheet. However, there is a great difference from the case of an adhesive in the ease of handling and the ease of storage after use.

If the surface of the support is a rough surface, the microporous suction sheet does not perform adsorption when the microporous suction sheet is pressed down. For example, when the support is a sheet of newspaper, a sheet of kraft paper, a sheet of quality paper, a sheet of copy paper, cloth, a sheet of synthetic paper and a mat plastic film (for example, a polyester film, polyethylene film or polypropylene film whose surface is matted), the microporous suction sheet does not adsorb the support. When the support is a sheet of coated paper, a sheet of cast-coated paper and a gloss plastic film (for example, a polyester film, polyethylene film or polypropylene film whose surface is glossed), the microporous suction sheet adsorbs the support well. However, as described above, there is a great difference from the case of an adhesive in the ease of handling and the ease of storage after use.

An unused display sheet comprising a microporous suction sheet can be wound onto a 3-inch core, for example, packaged and stored. Because the thickness of the display sheet is 400 to 600 microns and relatively large, there is a concern that winding wrinkles and creasing wrinkles might be formed due to the difference between the outside and inside diameters of the wound display sheet when the display sheet is wound onto the 3-inch core and stored. In order to prevent this concern, the release film of the present invention is an elastic and smooth ultrathin release film and the expansion and contraction property of the release film expressed by yield point elongation (elongation rate at yield point) is not less than 2%. Preferably, such a release film may be releasably stuck to the microporous suction sheet. As concrete examples of a release film, it is desirable to use a polyethylene film, a polypropylene film, a polymethylpentene film, etc. 10 to 100 microns in thickness.

Especially in the winding of a display sheet in which a polyester film not having the expansion and contraction property is used as the support, it is indispensable to use a release film which expands and contracts to follow the expansion and contraction of the microporous suction sheet. If a release film which does not perform expansion and contraction to follow the sheet-like member is used, wrinkles will inevitably be formed. In view of this fact, in the present invention it is preferred that an elastic and transparent polyethylene film, polypropylene film or polymethylpentene film 15 to 50 microns in thickness be used, and opaque or colored films may also be used.

In the display sheet for back surface application according to the present invention, on the surface of a microporous suction sheet are printed out display contents with a water base ink or an oil base ink and a transparent and smooth release film can be stuck over the printed surface.

As shown in FIG. 2, on the microporous suction sheet are formed 10,000 to 20,000 depression pores/cm², the diameters of these depression pores being 5 to 300 microns. When a water base ink or an oil base ink is directed toward the microporous suction sheet for printing out by use of an inkjet printer, much of the ink is delivered into the depression pores and fixed to perform printing. The water base ink or oil base ink, when delivered into the depression pores, penetrates into the microporous suction sheet, swells and softens an acrylic resin and/or a urethane resin, resulting in keeping adsorbability. While the ink which has been delivered into the depression pores and contained in them still keeps fluidity, the microporous suction sheet is coated preferably with a transparent and smooth release film or a transparent and smooth release film subjected to releasability treatment preferably by coating with silicone etc. and is pressed. Then, as shown in FIG. 5, the ink contained in the depression pores is pushed out by a press roll, dries and fixed to perform printing on the periphery of the openings of the depression pores on the surface of the microporous suction sheet. Thus, the microporous suction sheet can have a very characteristic feature of being easily printed on by use of an inkjet printer and simultaneously displaying the function of adsorption. The reason why a transparent release film is desirable is that the finish condition of printing can be checked through the release film. Furthermore, the release film is preferably subjected to releasability treatment as silicone coating. As a result, the ink is repelled by the release film and it is possible to prevent the ink from adhering to the release film. Therefore, when the release film is released, it is possible to cause much ink to be left on the microporous suction sheet and thereby to increase print density. Furthermore, by coating with the release film while the ink still keeps fluidity, it is possible to suppress the volatilization of the water base ink and the volatilization of a solvent of the oil ink, with the result that it is possible to keep the flexibility of the microporous suction sheet and to maintain its adsorbability until sticking work is started.

The relationship between the print density and print definition obtained by printing by use of an inkjet printer and the diameter of depression pores is such that as the diameter of depression pores is as fine as 5 to 30 microns and furthermore, the number of depression pores (for example, preferably not less than 100,000 pores/cm²) increases, the print density and print definition are improved. Moreover, if the thickness of the microporous suction sheet is 40 to 70 microns, both the print density and the print definition shows the best color developing properties. If the thickness of the microporous suction sheet becomes as large as 200 to 500 microns and there are many depression pores which are as large as not less than 300 microns, the ink which has been delivered into the depression pores and are contained in them does not reach the periphery of the openings by a press and much of the ink is still contained in the depression pores, with the result that the print density becomes low and the print definition becomes dull and worsens.

Moreover, the present invention provides a display sheet for back surface application which can further improve print density and print definition. That is, a printing receptive layer is formed on the surface of the microporous suction sheet, with display contents being printed out on the printing receptive layer with a water base ink or an oil base ink and a transparent and smooth release film or preferably a release film which is subjected to releasability treatment is stuck over the printed surface.

Preferably, the printing receptive layer is ultrathin and flexible to such a degree that the above-described the depression pores in microporous suction sheet are not completely filled, and the printing receptive layer is applied to the microporous suction sheet, dried and formed. When the coating thickness of the printing receptive layer is held to 1 to 10 microns after drying, adsorbability decreases a little. However, when printing is performed on the printing receptive layer, adsorbability is restored by either of a water base ink or an oil base ink and print density and print definition are also improved. If the coating thickness of the printing receptive layer is increased to not less than 20 microns after drying, the depression pores are buried under the printing receptive layer and adsorbability becomes lost. An inkjet printing receptive layer may be formed as the printing receptive layer.

In order to increase adsorbability, it is preferred that the microporous suction sheet be flexible and be smooth without limit and it is an important factor that the release film which covers the microporous suction sheet is smooth. This is because when the release film is coated on the microporous suction sheet, the smooth surface of the release film is transferred onto the microporous suction sheet because of the flexibility of the microporous suction sheet and the portion of the surface of the microporous suction sheet where there is no depression pore changes to a surface which is smooth without limit. However, when the release film is not smooth and a film the surface of which has fine bumps and dips, for example, a polyester film or a polyethylene film etc. having a matte surface is used as the release film, the adsorbability of the microporous suction sheet is lost to 1/10 or so. This is because as shown in FIGS. 7 and 8, the matte surface having the bumps and dips is transferred to the microporous suction sheet and air is vented from the gaps generated between the microporous suction sheet and the adherend, with the result that the suction sheet effect is lost. Therefore, it is possible to control the adsorbability of the microporous suction sheet between high and low levels by making a selection from release films having a very rough surface and those having a very smooth surface.

As described above, in order to ensure that the microporous suction sheet of the present invention displays its function, it is important that the acrylic resin and/or urethane resin which constitutes the microporous suction sheet be flexible so that the resin conforms well to an adherend not only at room temperature, but also at low temperatures as described in the Japanese Patent Publication No. 5-81614B and that the portion of the microporous suction sheet where there is no depression pore be smooth without limit. In order to obtain a smooth surface of the microporous suction sheet, it is desirable that the surface of the release film be smooth without limit. In contrast, when the surface of the release film is rough, the surface of the microporous suction sheet also becomes rough and the function of adsorption decreases according to the degree of the rough surface. However, the microporous suction sheet has an advantage that when the microporous suction sheet which has lost adsorbability because its surface has once become a rough surface is again coated with a smooth release film or is coated with a smooth release film after being swollen with the moisture of a water base ink or the solvent of an oil base ink and a definite time passes, the microporous suction sheet again recovers a smooth surface, with the result that adsorbability is restored. By making use of this advantage, it is possible to adopt a method which involves printing by use of a small-sized inkjet printer or general printing, such as offset printing and screen printing etc., with the adsorbability of the microporous suction sheet lost, coating a smooth release film after printing to permit the restoration of adsorbability and sticking thereafter the microporous suction sheet to an adhered.

The present disclosure relates to subject matter contained in Japanese Patent Application No. 2002-225348, filed on Jul. 1, 2002, which is expressly incorporated herein by reference in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is an enlarged sectional view of a display sheet related to the first embodiment of the present invention;

FIG. 2 is an enlarged perspective view of a microporous suction sheet of FIG. 1;

FIG. 3 is an enlarged sectional view of a display sheet related to the second embodiment of the present invention;

FIG. 4A is a perspective view of a display sheet in which a prescribed advertising display is created in an inkjet printing receptive layer with water base ink particles; FIG. 4B is a perspective view of a display sheet which is wound onto a paper tube firmly and compactly; FIG. 4C is an end view of the display sheet of FIG. 4B;

FIG. 5 is an enlarged sectional view of a display sheet related to the third embodiment of the present invention;

FIG. 6 is an enlarged sectional view of a display sheet related to the fourth embodiment of the present invention; and

FIGS. 7 to 10 are enlarged sectional views of a display sheet related to the fifth embodiment of the present invention.

### DETAILED DESCRIPTION OF THE PREFERRED EMBODIMENTS

The embodiments of the present invention will be described below by referring to the drawings.

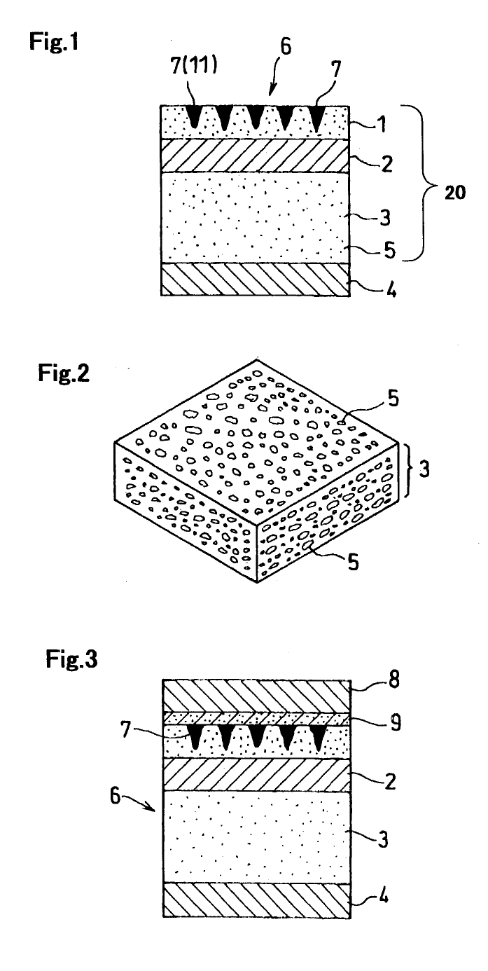

FIG. 1 is an enlarged sectional view of a sheet 6 for advertising posters, which is a display sheet related to the first embodiment of the present invention, and FIG. 2 is an enlarged perspective view of a microporous suction sheet 3 of FIG. 1. In FIG. 1, the sheet 6 for advertising posters has a sheet-like member 20, which comprises a support 2, a microporous suction sheet 3 formed on the back surface of the support 2, and a 20 to 40 micron thick inkjet printing receptive layer 1 which is formed on the surface of the support 2 and permits inkjet printing. This inkjet printing receptive layer 1 is impregnated with ink particles 7 to create a prescribed printing display. The microporous suction sheet 3 is a 30 to 500 micron thick flexible expanded resin coated layer in which an infinite number of fine and flexible depression pores 5 to 300 microns in diameter are formed. Furthermore, to the surface of the microporous suction sheet 3 is releasably stuck a release film 4 having a thickness of 10 to 100 microns and a degree of expansion and contraction expressed by yield point elongation of not less than 2%, preferably not less than 5% to protect the microporous suction sheet 3.

FIG. 3 shows a sheet 6 for advertising posters related to the second embodiment. The sheet 6 for advertising posters of the second embodiment differs from the first embodiment in that a surface protective film 8 is stuck to the surface of an inkjet printing receptive layer 1 via an adhesive 9, and is the same as the first embodiment in other points.

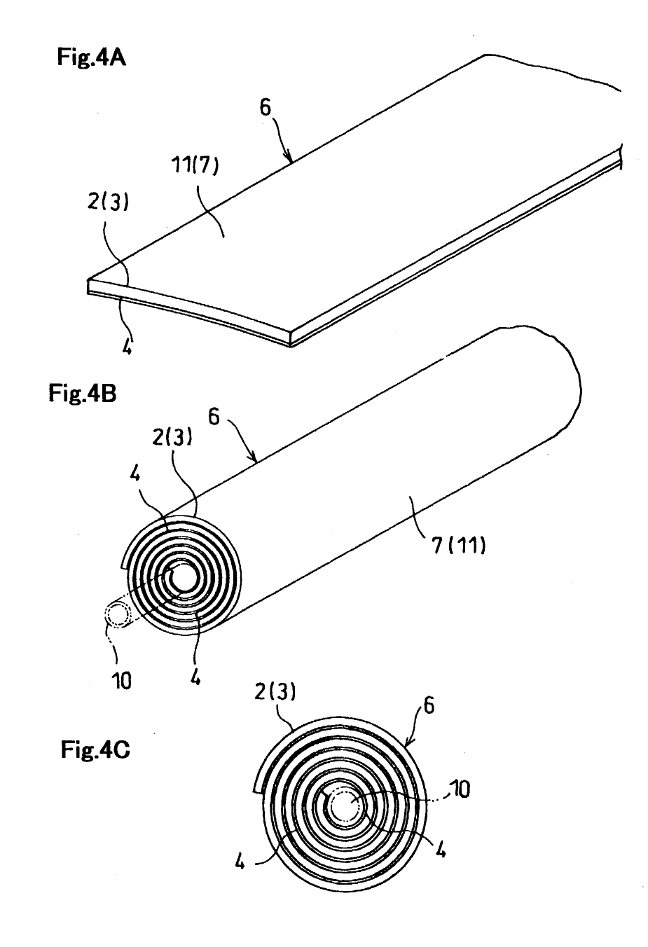

In FIG. 4A is shown a developed perspective view of a sheet 6 for advertising posters in which a prescribed advertising display 11 is created in an inkjet printing receptive layer 1. In FIGS. 4B and 4C is shown a sheet 6 for advertising posters which is wound onto a paper tube 10 firmly and compactly.

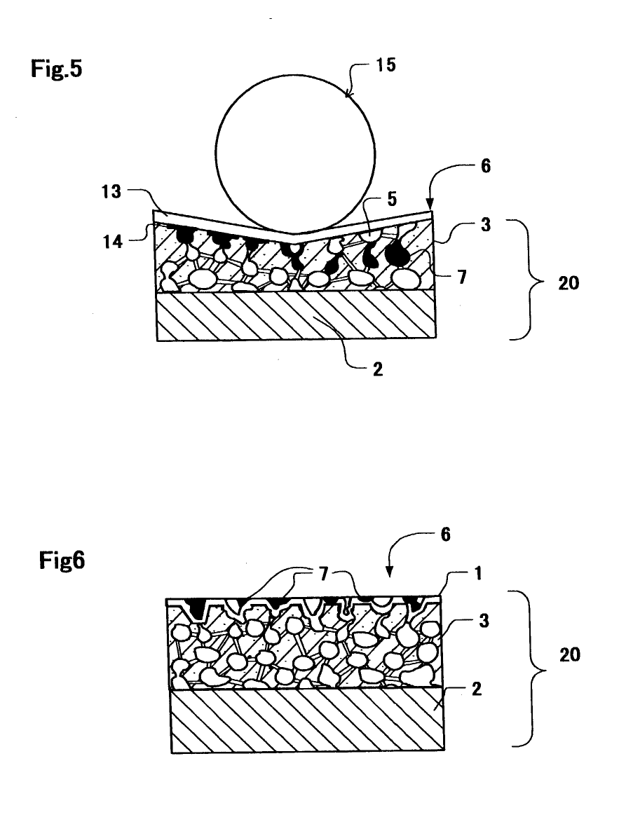

FIG. 5 shows a sheet 6 for advertising posters for back surface application related to the third embodiment. After performing print out on a microporous suction sheet 3 disposed on the back surface of a support 2 directly by use of an inkjet printer, the microporous suction sheet 3 is coated with a transparent and smooth plastic film 13 subjected to releasability treatment, for example, by silicone coating (a release film 13) and the microporous suction sheet 3 is pressurized from above the film by use of a press roll 15, whereby an ink 7 delivered into depression pores 5 is pushed out to openings 14 of the depression pores 5 of the microporous suction sheet 3. FIG. 5 is an enlarged sectional view before and behind the press roll 15.

FIG. 6 shows a sheet 6 for advertising posters for back surface application related to the fourth embodiment. An inkjet receptive layer 1 is formed on the surface of a microporous suction sheet 3. As a result of print out by use of an inkjet printer, this inkjet receptive layer 1 is impregnated with ink particles 7 to create a prescribed print display.

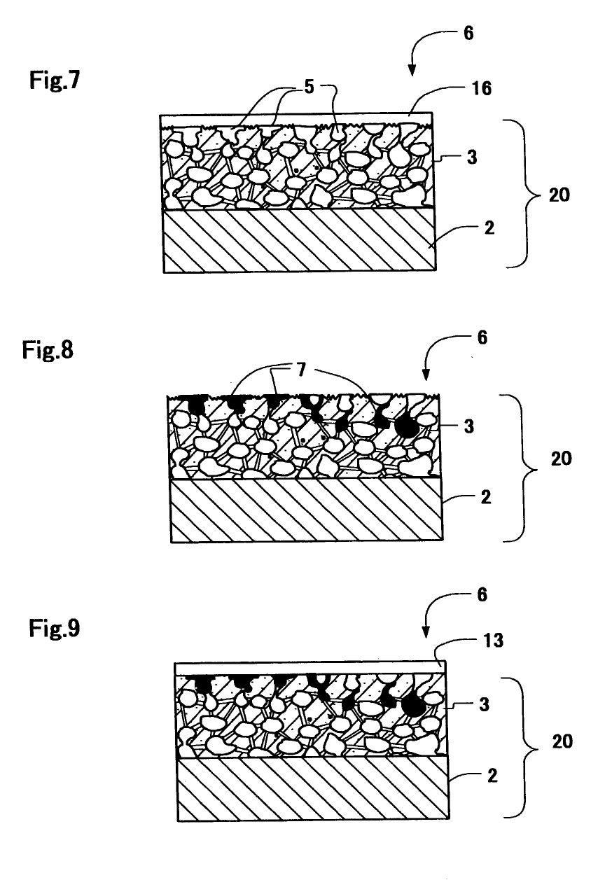

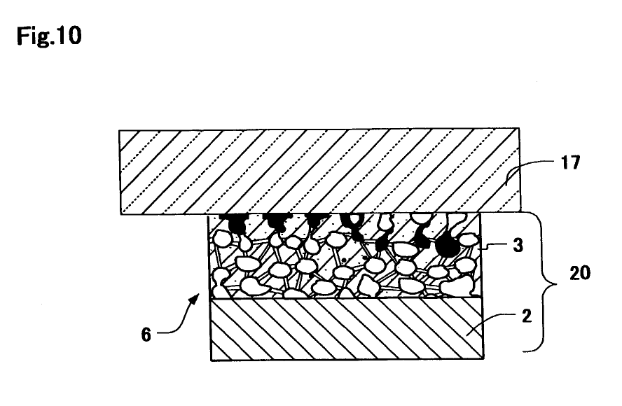

FIGS. 7 to 10 show a sheet 6 for advertising posters for back surface application related to the fifth embodiment. As shown in FIG. 7, a release film 16 having a rough surface is coated on the surface of a microporous suction sheet 3, and owing to the effect of this release film 16, the portion of the surface of the microporous suction sheet 3 where depression pores 5 are not formed shows a rough surface and hence the function of adsorption is in a reduced condition. In this condition, the release film 16 is released and printing is performed without the existence of adsorbability (FIG. 8). Under the condition, general printing, such as offset printing and screen printing, can be performed as well as inkjet printing. The microporous suction sheet 3 is impregnated with ink particles 7 to create a prescribed print display. In this condition, the microporous suction sheet 3 is coated with a transparent and smooth plastic film (a release film) 13 (FIG. 9). And when a definite time passes, the surface of the microporous suction sheet 3 where depression pores 5 are not formed recovers a smooth surface and adsorbability is restored. This enables, as shown in FIG. 10, back surface application to be performed by releasing the release film 13 and sticking the microporous suction sheet 3 to a transparent adherend 17.

Embodiments in which the above-described display sheet is fabricated by the following process will be described below.

### EXAMPLE 1

In order to form a microporous suction sheet 3, by use of a mechanical foaming machine air was mixed with an acrylic emulsion prepared by mixing an acrylic copolymer resin DICNAL MEP-20, a foaming agent M-20, a foaming control agent DICNAL M-40, a puffing agent DICNAL MX, a crosslinking agent DICNAL GX (all of the above chemicals being made by Dainippon Ink & Chemicals Inc.) at a ratio of 1:0.04:0.04:0.01:0.02, and a foamy acrylic emulsion liquid with a foaming magnitude of 1.5 times was prepared. By use of a comma coater this foamy acrylic emulsion liquid was uniformly applied in an amount of 280 g/m² to the back surface of a support 2 of polyester film (IJ-F-FJA, width 1280 mm (made by Mitsubishi Paper Mills, Ltd.)), to the front surface of which an inkjet printing receptive layer had been applied beforehand. After that, drying was performed in a drying oven at 140° C. for 9 minutes and cooling was performed. After that, by use of a laminator a microporous suction sheet 3 formed to have a thickness of 250 microns was coated with a release film 4 comprising a 20 micron thick polypropylene film and having a yield point elongation of 10%, and a 600 m long sheet for advertising posters was thus produced.

This product was wound onto a paper tube 10 in 30 m long coils and packaged. After checking for occurring no winding wrinkles etc., the coils were unwound and a prescribed design was printed on the inkjet printing receptive layer 1 with an area of 1200 mm×2000 mm by use of an inkjet printing machine (CJ-500 made by Roland Corporation) and two sheets of advertising poster having a microporous suction sheet were completed.

In order to stick one of the two sheets to an outdoor windowpane of a store, a surface protective film 8 comprising a 50 micron thick transparent matte polyvinyl chloride film M-009PN80 (made by LINTEC CORPORATION) was laminated over the inkjet printing receptive layer 1 of the advertising poster having the microporous suction sheet and the sheet was wound onto a 3-inch core and delivered to the store where its sticking work was carried out. The other sheet was wound onto a 3-inch core without a protective film laminating and delivered to the store where its sticking work was carried out.

In the sticking work of the above-described advertising poster to an outdoor windowpane, an employee of the store who was an amateur was in charge of the work. The employee carried out the sticking work by releasing the release film 4. This advertising poster having a microporous suction sheet was adsorbed and stuck to the windowpane without sticking to the hands of the worker. Although the advertising poster was stripped several times in order to correct the sticking position, the sticking work was completed in 15 minutes. When similar sticking work was carried out by use of an advertising poster with paste, it took about 60 minutes for a skilled experienced person to complete the sticking work.

After a week the stuck advertising poster was easily manually stripped by the employee of the store and easily wound onto a 3-inch paper tube and stored for reuse. After three months, the advertising poster was unpacked and unwound. The wound advertising poster could be unwound although there was some resistance because of the adsorption of roll turns in the unwinding. The advertising poster thus unwound was again stuck to the same windowpane by an employee of the store in the same way as last time and the work was completed in 12 minutes.

The other advertising poster having a microporous suction sheet which had been wound onto a 3-inch core without a protective film laminating and delivered to the store where its sticking work was carried out, was also stuck, stored and reused by an employee of the store in parallel with the above-described laminated advertising poster and the same results of good workability, good releasability, good storability, etc., as with the laminated advertising poster were obtained. Especially in the unwinding work of the roll after unpacking which was carried out after 3 months, the adsorbability between the inkjet printing receptive layer 1 having fine bumps and dips in the surface and the microporous suction sheet 3 did not damage the weak inkjet printing receptive layer and the advertising poster was easily unwound in spite of the firm and compact winding onto a 3-inch paper tube.

### EXAMPLE 2

Next, an embodiment which permits direct printing onto a microporous suction sheet 3 by use of an inkjet printer and the restoration of adsorbability will be described below.

Sheets for advertising posters of 3 m length were taken from the 600 m long advertising poster fabricated in the first embodiment, release films 4 were stripped, release films 13 comprising a transparent and smooth polyester film subjected to silicone coating treatment were coated on a print surface of one of the sheets for advertising poster in 5 minutes after the outputting of display contents (Condition 1), on a print surface of another sheet for advertising poster in 15 minutes after the outputting of display contents (Condition 2) and on a print surface of the other sheet for advertising poster in 30 minutes after the outputting of display contents (Condition 3) onto the surfaces of microporous suction sheets 3 with water base pigment ink by use of an inkjet printer (CJ-500 made by Roland Corporation), respectively, the release film 13 was each laminated during pressurization under a pressure of 1.3 kilos at a rate of 5 m/minute by use of a laminator LMH-1400 (made by LAMI CORPORATION), and advertising posters for back surface application were completed. The print surfaces fabricated under the above-described three conditions were compared. The print density was highest under Condition 1 under which the water base ink still kept fluidity during laminating under pressurization, and the printability was lowest under Condition 3 under which the water base ink lost fluidity. In parallel with the above-described test, release films 13 comprising a transparent and smooth polyester film not subjected to silicone coating treatment were coated under the above-described three conditions and laminated during pressurization, and the degree of ink adhering to the polyester film was compared. The adhering of the ink was not observed in the transparent and smooth polyester film subjected to silicone coating treatment, whereas the adhering of the ink was observed in the transparent and smooth polyester film not subjected to silicone coating treatment. And in the latter case, when the polyester film was stripped, it was found that the print density of the microporous suction sheet decreases by an amount of ink adherence.

The 1 m×1 m advertising posters to which a transparent and smooth polyester film subjected to silicone coating treatment was coated under Conditions 1 to 3 described above were allowed to stand for ten days. After that, the advertising posters were stuck to a windowpane after stripping the release film 13. All of the advertising posters were very easy to stick, re-sticking was also easy without remaining paste, adsorbability was restored and high, and the ink did not adhere to the glass surface. Thus it was confirmed that these advertising posters permit even an amateur easy sticking work.

### EXAMPLE 3

Sheets for advertising posters of 3 m length were taken from the 600 m long sheet for advertising posters fabricated in the first embodiment, release film 4 were stripped and by use of an inkjet printer (LAMILESS made by Mutoh Kogyo, Co.) display contents were printed out onto the surface of a microporous suction sheets 3 with an oil base pigment ink. One of advertising posters in which a release film 4 comprising a 60 micron thick polyethylene film was coated on the surface of the microporous suction sheet 3 in 15 minutes after printing (Condition 1) and another advertising poster which was allowed to stand in a natural state without coating (Condition 2) were fabricated and stored. The polyethylene film was stripped after one day, after 7 days and after a month and the adsorbability of the microporous suction sheet 3 was checked each time. In the advertising poster fabricated under Condition 1 its adsorbability was confirmed on all the three occasions after 1 day, 7 days and a month, whereas in the advertising poster fabricated under Condition 2 its adsorbability was lost already after one day. In the advertising poster which had been allowed to stand in a natural state, the solvent of the oil base ink vaporized and the surface flexibility of the microporous suction sheet 3 was lost.

The release film 4 comprising a polyethylene film was stripped after a month from the advertising poster fabricated under Condition 1 described above and this advertising poster was stuck to a windowpane by back surface application. The transfer and adherence of the ink to the glass surface did not occur, adsorbability did not decrease and it was ascertained that re-releasability is also good. This means that the release film 4 comprising the polyethylene film has the function of storing the solvent of the oil base pigment ink.

### EXAMPLE 4

A sheet for advertising posters of 3 m length was taken from the 600 m long sheet for advertising posters fabricated in the first embodiment, a release film 4 was stripped, and by use of a comma coater a coating solution for a water base ink of an inkjet printing receptive layer 1 (MIU555A made by Master Mind Inc.) was applied to the surface of a microporous suction sheet 3 so as to form an inkjet printing receptive layer 1 with a coating thickness of 3 microns, and the applied coating solution was dried. After drying, a release film 13 comprising a 30 micron thick elastic polyethylene film was coated (Condition 1).

By use of an inkjet printer (CJ-500 made by Roland Corporation) display contents were output with a water base pigment ink onto the inkjet printing receptive layer 1 formed on the surface of the microporous suction sheet 3. At the same time, for a comparison, display contents were also output onto the surface of the microporous suction sheet 3 in which the inkjet printing receptive layer 1 was not coated on the microporous suction sheet 3 (Condition 2). As a result of a comparison of print surfaces in terms of print density, print definition and the restoration of adsorbability, it was found that the print surface obtained under Condition 1 is excellent in the color developing properties of the ink and in print definition compared to the print surface obtained under Condition 2. Although the adsorbability under Condition 1 decreased by about 20% compared with the adsorbability under Condition 2, the display could be used sufficiently.

### EXAMPLE 5

In the fabrication of the sheet for advertising posters described in the first embodiment, in place of the 20 micron thick polypropylene film having a smooth surface a matte 30 micron thick polyethylene film having fine bumps and dips on its surface (made by Toyobo Co., Ltd.) was coated as a release film 16 on the surface of a microporous suction sheet 3 so as to ensure the contact of the matte surface and laminated during pressurization under a pressure of 1.3 kg/cm² at a rate of 5 m/minute, and a 300 m long sheet for advertising posters was fabricated by being wound onto a 3-inch paper tube. When after two weeks of aging the winding was wound and the release film 16 was stripped, it was found that the matte surface of the release film 16 had been transfer-printed on the surface of the microporous suction sheet and hence the adsorbability had been lost. On a trial basis, when the adsorbability to a glass surface was measured, it was found that the adsorbability had been reduced to 1 g/30 mm. On the other hand, the adsorbability was 13 g/30 mm when a release film 4 having a smooth surface was used. Therefore, it became apparent that the adsorbability decreases to not more than 1/10 when the matte release film 16 is used. This sheet for advertising posters having adsorbability reduced to not more than 1/10, from which the release film 16 was stripped, was cut to A4 size sheets and 300 such sheets were stored in piles. However, these 300 sheets did not adsorb each other during the storage and 100 out of the 300 sheets could be continuously screen printed without a problem. In 50 sheets out of these printed 100 sheets, by use of an inkjet printer (PM720C made by SEIKO EPSON CORPORATION) display contents were printed out onto both of the surface of the inkjet printing receptive layer 1 and the surface of the microporous suction sheet 3 with a water base dye ink. The sheets were threaded through the printing machine without a problem and double-sided printing could be performed. However, in the sheets for advertising posters from which the release film 4 having a smooth surface (the 20 micron thick polypropylene film) had been stripped, the surface of the microporous suction sheet adsorbed the screen printing plate and printing was impossible. Furthermore, printing out was impossible because of adsorption of the interior of the inkjet printer (PM720C made by SEIKO EPSON CORPORATION). Inkjet output printed matters obtained by performing inkjet printing after the use of the matte release film 16, the adsorbability was restored by the water base dye ink and the printed matters adhered well to a glass surface. Screen printed matters were provided with adsorbability again by water-blow to microporous suction sheet and water absorption therein, thereby adhering to glass surfaces.

While the invention has been described in terms of several preferred embodiments, those skilled in the art will recognize that the invention can be practiced without modification within the spirit and scope of the appended claims.

What is claimed is:

1. A display sheet comprising:
a sheet-like member,
said sheet-like member comprising a 30 to 500 micron thick flexible microporous suction sheet in which an infinite number of fine and flexible depression pores 5 to 300 microns in diameter are formed; and
a release film,
said release film releasably covering a surface of the microporous suction sheet to protect the microporous suction sheet, being 10 to 100 micron thick and having a yield point elongation of not less than 2%,
wherein a surface of said sheet-like member being capable of becoming a display surface of display contents.

2. The display sheet according to claim 1, wherein said sheet-like member comprises a support and said microporous suction sheet is formed on a back surface side of the support.

3. The display sheet according to claim 1, wherein said sheet-like member comprises a 10 to 100 micron thick printing receptive layer capable of printing which is formed on a surface of the support.

4. The display sheet according to claim 1, wherein said sheet-like member further comprises a protective film adhered to the surface thereof.

5. The display sheet according to claim 1, wherein said release film is a smooth ultrathin film.

6. The display sheet according to claim 1, wherein said release film is a nonsmooth ultrathin film.

7. The display sheet according to claim 1, wherein said release film is an ultrathin film having an elastic uneven surface, the adsorbability of the microporous suction sheet being arbitrarily controlled by changing the degree of unevenness of the surface of said release film.

8. The display sheet according to claim 2, wherein a surface of said support is a rough surface and during the storage for reuse said rough surface and said microporous suction sheet slide relative to each other so as to permit winding up, enabling firm winding.

9. The display sheet according to claim 3, wherein a surface of said printing receptive layer is a rough surface and during the storage for reuse said rough surface and said microporous suction sheet slide relative to each other so as to permit winding up, enabling firm winding.

10. The display sheet according to claim 4, wherein a surface of said protective film is a rough surface and during the storage for reuse said rough surface and said microporous suction sheet slide relative to each other so as to permit winding up, enabling firm winding.

11. The display sheet according to claim 3, wherein said printing receptive layer is a printing receptive layer for inkjet printing.

12. The display sheet according to claim 1, said sheet-like member comprises a printing receptive layer capable of printing which is formed on a surface of the microporous suction sheet, the thickness of the printing receptive layer being such that the depression pores in said microporous suction sheet are not buried.

13. The display sheet according to claim 12, wherein said printing receptive layer is a printing receptive layer for inkjet printing.

14. An advertising poster in which advertisement contents are displayed on the sheet-like member according to claim 1.

15. A display sheet in which display contents are printed out with a water base ink or an oil base ink on a surface of a 30 to 500 micron thick flexible microporous suction sheet in which an infinite number of fine and flexible depression pores 5 to 300 microns in diameter are formed, a transparent smooth release film being stuck to the printed surface.

16. The display sheet according to claim 15, wherein said release film is stuck to the printed surface while being pressurized.

17. The display sheet according to claim 15, wherein a printing receptive layer is formed on a surface of said microporous suction sheet, and a thickness of the printing receptive layer is such that the depression pores in said microporous suction sheet are not buried, display contents being printed out on the printing receptive layer with a water base ink or an oil base ink.

18. The display sheet according to claim 15, wherein said transparent smooth release film is subjected to releasability treatment.

19. The display sheet according to claim 17, wherein said printing receptive layer is a printing receptive layer for inkjet printing.

20. An advertising poster in which advertisement contents are displayed on the surface of the microporous suction sheet according to claim 15.

21. A method of performing front surface application of a display sheet including a sheet-like member comprising a support and a 30 to 500 micron thick fine and flexible microporous suction sheet which is disposed on a back surface side of the support and in which an infinite number of fine and flexible depression pores 5 to 300 microns in diameter are formed, and a release film with a smooth surface, a thickness of 10 to 100 microns and a yield point elongation of not less than 2% which releasably covers a surface of the microporous suction sheet to protect the microporous suction sheet, said method comprising the steps of:
printing a content to be printed on a surface of the support;
stripping the release film from the microporous suction sheet; and
sticking the microporous suction sheet to an adherend.

22. The method of performing front surface application of a display sheet having a suction sheet according to claim 21, further comprising the steps of:
stripping the microporous suction sheet from the adherend;
firmly winding and storing the sheet-like member; and
sticking the microporous suction sheet to the adherend for reuse.

23. The method of performing front surface application of a display sheet according to claim 21, wherein a printable 10 to 100 micron thick printing receptive layer is formed on a front surface side of said support and said step of printing includes a step of printing a content to be printed on the printing receptive layer.

24. A method of performing back surface application of a display sheet including a sheet-like member comprising a 30 to 500 micron thick flexible microporous suction sheet in which an infinite number of fine and flexible depression pores 5 to 300 microns in diameter are formed,
and a release film with a thickness of 10 to 100 microns which releasably covers a surface of the microporous suction sheet to protect the microporous suction sheet, said method comprising the steps of:
stripping the release film from the display sheet;
printing a content to be printed on a surface of the microporous suction sheet;
covering the surface of the microporous suction sheet with a release film with a smooth surface after printing;
re-stripping said release film with the smooth surface from the microporous suction sheet; and
sticking the microporous suction sheet to an adherend.

25. The method of performing back surface application of a display sheet having a suction sheet according to claim 24, wherein the step of covering the surface of the microporous suction sheet with said release film with the smooth surface after printing is performed while pressurizing.

26. The method of performing back surface application of a display sheet having a suction sheet according to claim 24, wherein the step of covering the surface of the microporous suction sheet with said release film with the smooth surface after printing is performed while a print ink still keeps fluidity.

27. The method of performing back surface application of a display sheet having a suction sheet according to claim 24, wherein a printing receptive layer is formed on a front surface side of said microporous suction sheet and said step of printing includes a step of printing a content to be printed on the printing receptive layer.

28. The method of performing back surface application of a display sheet having a suction sheet according to claim 24, further comprising the steps of:
stripping the microporous suction sheet from the adherend;
firmly winding and storing the sheet-like member; and
sticking the microporous suction sheet to the adherend for reuse.

29. A method of performing back surface application of a display sheet including a sheet-like member comprising a 30 to 500 micron thick flexible microporous suction sheet in which an infinite number of fine and flexible depression pores 5 to 300 microns in diameter are formed,
and a release film with a thickness of 10 to 100 microns and a nonsmooth surface which releasably covers a surface of the microporous suction sheet to protect the microporous suction sheet, said method comprising the steps of:
stripping the release film from the display sheet;
printing a content to be printed on a surface of the microporous suction sheet;
covering the surface of the microporous suction sheet with a release film with a smooth surface after printing;
re-stripping said release film with the smooth surface; and
sticking the microporous suction sheet to an adherend.
